(19) United States
(12) Patent Application Publication
(10) Pub. No.: US 2004/0245150 A1
(43) Pub. Date: Dec. 9, 2004

(54) Extended sorting machine

(76) Inventors: Robert L. Stone, Rockford, MI (US); Jeffrey D. Price, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/733,994

(22) Filed: Dec. 11, 2003

Related U.S. Application Data
(60) Provisional application No. 60/471,547, filed on May 19, 2003.

(51) Int. Cl. B04B 5/10

(52) U.S. Cl. 209/12.1

(57) ABSTRACT

A sortation assembly for sorting articles includes first and second substantially straight sections and a curved section between the first and second straight sections. The sortation assembly includes a plurality of chutes that are movable along the first and second straight sections and the curved section in a continuous loop. Each of the straight sections includes a plurality of sort stations along at least one side. The chutes are movable along and over the sort stations of both straight sections and are operable to deposit articles to bins or trays positioned at the sort stations. The curved connecting section guides the chutes between the first and second straight sections, which may be arranged at an angle relative to one another.

### CROSS REFERENCE TO RELATED APPLICATION

The present application claims priority of U.S. provisional application Ser. No. 60/471,547, filed May 19, 2003, which is hereby incorporated herein by reference in its entirety.

### FIELD OF THE INVENTION

The present invention relates generally to sorting machines and, more particularly, to flats mail sorting machines operable to sort articles of mail into containers or bins.

### BACKGROUND OF THE INVENTION

Flats mail sortation assemblies are known and function to sort articles of mail into particular containers or trays depending on the destination of the articles. The sortation assemblies typically include an induct for inducting articles, such as mail, into a sortation mechanism, which includes a carousel which deposits articles into particular chutes or buckets. The chutes are moved along the sortation assembly in a continuous loop and deposit the articles into containers positioned at sort stations under the chutes and along the sortation assembly. Examples of such sortation assemblies are the flat-sorting system of the type marketed by Alcatel Postal Automation System and/or Mannesmann Dematic Postal Automation and/or Mannesmann Dematic Rapistan Corp. and/or Siemens Dematic Corp. under Model AFSM100, or the sortation assembly marketed by Lockheed Martin Postal Automation under Model FSM 1000 or any other known flat mail sortation systems. The sortation assemblies typically provide 120 bins or sort stations and three inducts for feeding articles to the chutes.

### SUMMARY OF THE INVENTION

The present invention provides for a sortation assembly which may include approximately 200 (or more) sort stations and bins or containers for receiving articles of mail from the chutes or buckets of the sortation mechanism. The sortation assembly includes a curved section between at least two straight sections to allow for a change in direction or orientation of the assembly, in order to provide a different shaped assembly to adapt the assembly to a desired layout for a particular facility.

According to an aspect of the present invention, a sortation assembly includes a plurality of chutes movable along a continuous loop. The chutes are movable along first and second straight sections of the sortation assembly. Each of the straight sections includes a plurality of sort stations along each side. The chutes are movable along and over the plurality of sort stations of both straight sections and are operable to deposit articles to bins or trays at the sort stations. The sortation assembly includes a curved connecting section which guides the plurality of chutes between the first and second straight sections.

In one form, the straight sections are oriented generally orthogonal to one another, such that the sortation assembly is formed in a generally L-shaped pattern, with the curved connecting section providing approximately a 90 degree bend in the travel of the chutes. In another form, the straight sections are oriented generally parallel to one another, such that the sortation assembly is formed in a generally U-shaped pattern, with a single 180 degree curved connecting section or two 90 degree curved connecting sections between the straight sections, depending on the particular application. Other shapes may be formed or implemented to adapt the sortation assembly for the space constraints of the targeted facility, without affecting the scope of the present invention.

The sortation assembly may include a plurality of inducts at one end of one of the straight sections of the assembly. Optionally, the sortation assembly may include a plurality of inducts at both ends of the assembly. Optionally, the sortation assembly may include one or more inducts at the curved connecting section.

According to another aspect of the present invention, a method for extending a sortation assembly includes providing first and second straight sections of a sortation assembly, each having a plurality of sort stations therealong. The method includes providing a curved section between the first and second straight sections. A plurality of chutes are provided for moving in a generally continuous loop around the straight sections and curved section of the assembly. The chutes are mounted to a chain or the like and spaced therealong a sufficient amount to allow the chutes and chain to curve along the curved section without contact or interference occurring between adjacent chutes. The chutes are moved along the generally straight sections and the curved section to deposit articles into bins or trays positioned at the sort stations.

The chutes may be movable around the continuous loop via a chain along the straight sections and the curved section. The method may include providing or spacing the chutes along the chain at an increased pitch or separation distance to allow for the chutes to curve along the curved section.

Therefore, the present invention provides an extended sortation assembly which may include 200 bins or any desired number of bins, and which may be formed to a desired shape to adapt to the space constraints at the facility. The sorting machine of the present invention thus is adaptable to suit various floor plans and space constraints at a targeted facility. The sorting machine may provide an increased amount of sorting stations while limiting the space required for the machine.

These and other objects, advantages, purposes and features of the present invention will become apparent upon review of the following specification in conjunction with the drawings.

### BRIEF DESCRIPTION OF THE DRAWINGS

FIG. 1 is a top plan view of a generally U-shaped sortation assembly in accordance with the present invention;

FIG. 2 is a top plan view of another generally U-shaped sortation assembly in accordance with the present invention, with inducts positioned at both ends of the sortation assembly; and

FIG. 3 is a top plan view of a generally L-shaped sortation assembly in accordance with the present invention.

### DESCRIPTION OF THE PREFERRED EMBODIMENTS

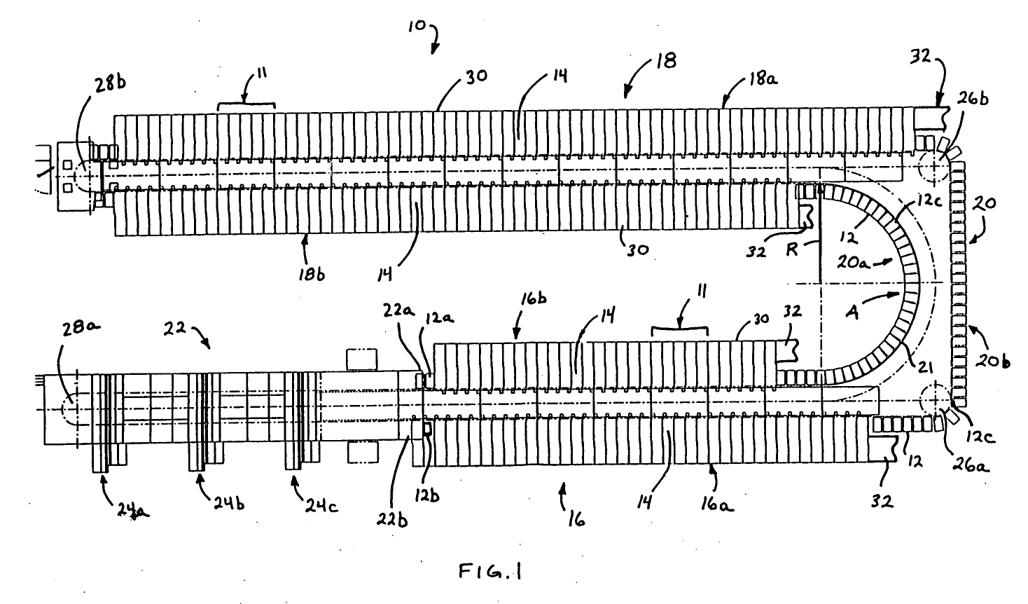

Referring now specifically to the drawings and the illustrative embodiments depicted therein, a sortation assembly 10 includes a carousel (not shown) which deposits articles into particular chutes or buckets 12, which are movable in a generally continuous loop along and around the sortation assembly 10 (FIG. 1). The chutes 12 are movable over sort stations 14 positioned along the sides of the sortation assembly 10 and are operable to deposit the articles into appropriate bins, trays or containers (not shown) at the sort stations 14. As shown in FIG. 1, sortation assembly 10 includes a first straight section 16, along which multiple bins are positioned, a second straight section 18, along which more bins are positioned, and a curved or arcuate section 20 connecting the opposed or adjacent ends of the straight sections. The bins are positioned along each side of each straight section. The chutes 12 are moved along the straight and curved sections 16, 18, 20 of sortation assembly 10 by a drive member or driven chain or the like 21 which is routed around the sortation assembly 10.

As shown in FIG. 1, sortation system 10 includes an induct end 22, which may include three inducts 24a, 24b, 24c, at an end of one of the straight sections 16 opposite from the curved section 20. As is known in the art, articles are supplied to the inducts 24a, 24b, 24c and deposited into the chutes 12 as the chutes move around the induct end 22. For example, empty chutes 12a may enter the induct end 22 at entry 22a and receive articles as the chutes 12 move through and along induct end 22, whereby generally filled chutes 12b may exit the induct end at exit 22b and proceed along the sort assembly 10 to deposit the articles into the appropriate bins of the sort stations 14.

Each of the straight sections 16, 18 includes a plurality of sort stations 14 along one or both sides. In the illustrated embodiment, the straight sections comprise multiple modules 11, each of which may include five sort stations along each side. Any number of modules 11 may be connected together to form a straight section or sections of a desired length. Each sort station 14 supports a respective bin or tray while the bin is filled by the chutes moving over the sort stations. After the bin has been filled, the filled bin is removed from the station and a new, empty bin is provided at the station for filling with articles. Although the chutes are movable along and over the sort stations 14 along the straight sections 16, 18, the chutes 12 are not shown over the stations in the FIGS. 1-3 for purposes of clarity.

The curved section 20 includes an arcuate portion defining an inner curve 20a and at least one sprocket 26 which defines an outer curve 20b. As can be seen in FIG. 1, the chutes 12 are mounted to the chain 21 along one side 12c of the chutes, such that the chutes separate or flare out as they travel around sprockets or guides which are radially inward of the chutes, such as shown as the chutes travel around sprockets 26a, 26b of the outer curve 20b of curved section 20. Although not shown, the chutes also separate or flare out as they travel around sprockets 28a, 28b at the end of the respective straight sections 16, 18.

As the chutes travel around the inner curve 20a of curved section 20, the chutes are pivoted toward one another and may contact or interfere with one another at their ends or sides opposite from the chain, as shown generally at A in FIG. 1. The separation distance of the chutes 12 along the chain 21 thus may determine the minimum radius R of the inner curve 20a of curved section 20. The greater the separation of the chutes along the chain, the smaller the radius of curvature may be for inner curve 20a. The chain and buckets are moved along a track along the inner curve 20a. The track may be substantially the same as the track typically used in known sortation machines.

The pitch of the chain or separation of the buckets or chutes along the chain may be selected to provide a desired amount of separation of the chutes in accordance with the desired curvature of the curved section. In the illustrated embodiment, the chutes are separated to allow for a radius of curvature of the inner curve of approximately 10 feet (3 meters). For example, this amount of separation is the result of an increase in the pitch of or separation distance between the buckets on the chain by approximately 1½ inches over the pitch of or separation distance between the buckets on the chain of a conventional sorting machine, such as used for an AFSM 100 sorting machine.

During operation, articles of mail are loaded into the inducts 24a, 24b, 24c, which fill or at least partially fill the chutes 12 at the induct end 22 of sortation assembly 10. The chutes are moved from induct end 22 along respective sides of the straight and curved sections and then reversed at sprocket 28b and returned to induct 22 along opposite respective sides of the straight and curved sections. For example, the chutes may move from exit 22b of induct end 22, along an outer side 16a of the first straight section 16, along and around the outer curve 20b of the curved section 20, along an outer side 18a of the second straight section to sprocket 28b. The chutes may then travel back along an inner side 18b of the second straight section 18, the inner curve 20a of the curved section 20, and an inner side 16b of the first straight section 16 to entry 22a of induct end 22. The chutes thus may move in a continuous loop around the sortation assembly and may deposit the articles into the appropriate bins positioned along the straight sections 16, 18. After the bins have been filled or at least partially filled by the chutes, the bins are removed from the sort station and replaced with an empty tray, so that the sort and fill process may continue.

Optionally, a tray handling system 30 may be provided which is operable to discharges full trays automatically to an output or discharge end 32 at a respective end of each of the straight sections 16, 18. Each straight section may include a separate tray handling system which covers both sides of the respective straight section. Each tray handling system and discharge end may include a conveyor, such as a belt conveyor, powered roller conveyor, or the like. The tray handling system 30 may be operable to automatically replace the full tray with an empty tray after the full tray has been removed from the sort station and moved toward the discharge end 32. A preferred form of tray handling system 30 is disclosed in commonly assigned U.S. Pat. No. 6,561,339, which is hereby incorporated herein by reference. The tray handling system 30 conveys partially filled trays from the sortation system along a respective side of a respective one of the straight sections to the discharge end 32, whereby the trays are conveyed past the curved section 20 and discharged from the system for further handling at the facility.

Optionally, the tray handling system may be interconnected with a delivery point sequencing system (not shown), which is operable to sequence the trays after a first sort pass through the sortation assembly in a desired order or sequence for a second pass through the sortation assembly, whereby the articles are sorted to a delivery point or carrier route depth of sort following the second sort pass. Examples of such a delivery point sequencing system are disclosed in U.S. Pat. No. 6,501,041; and/or U.S. patent application Ser. No. 10/135,491, filed Apr. 30, 2002 by Burns et al. for DELIVERY POINT SEQUENCING MAIL SORTING SYSTEM WITH FLAT MAIL CAPABILITY (Attorney Docket RAP04 P-629C), which are hereby incorporated herein by reference. Because the sortation assembly or system of the present invention may provide a greater number of bins or sort stations over conventional 120 bin machines, the sortation system of the present invention is particularly suited for applications with delivery point sequencing capabilities. Also, because the sortation assembly of the present invention may be compressed in length and have a wider footprint, an over-top delivery point sequencing system (such as disclosed in U.S. patent application Ser. No. 10/135,491, referenced above) may provide greatly enhanced capacity and flexibility, since the delivery point sequencing system may be expanded to cover the wider footprint of the sortation assembly of the present invention.

In the illustrated embodiment of FIG. 1, the first straight section 16 includes seventy bins or stations, but may include other quantities, depending on the application and desired layout of sortation assembly 10. The second straight section 18 includes 130 bins or stations, such that the illustrated embodiment of sortation assembly 10 provides 200 bins for sorting articles into, while maintaining a small enough footprint to be applicable in many facilities. In the illustrated embodiment, the overall width of the sortation assembly is only approximately 35 feet (10.55 meters), while the length is only approximately 91 feet (27.8 meters), which is less than the length of a known 120 bin sorting machine, such as the AFSM 100. The sortation assembly of the present invention thus provides a much greater number of sort bins or stations, without a significant adverse affect on the space that the assembly occupies in the facility. It is further envisioned that additional bins may be provided along the outer curve portion 20b between the sprockets 26a, 26b, thereby further increasing the throughput of the sortation assembly.

Also, because the present invention may provide two generally parallel sort lines, increasing the overall length of the sortation assembly by adding additional modules 11 or chutes 12 and bins will double the number of additional chutes and bins over the same increase in length for a known, single line sorting machine. For example, if a module were added to a linear sorting machine, the sorting machine would increase in length by approximately 5.7 feet (1.7 meters) and would have, for example, ten additional bins (such as five bins on each side of the machine). However, if the sortation assembly of the present invention were increased in overall length by the same amount (the length of one module), the sortation assembly may have twenty additional bins (two modules added, resulting in five additional bins on each side of both sections), thus providing a greater enhancement of the sortation assembly for the same increase in overall length of the assembly. It is further envisioned that a second curved section and a third straight section may be added to the end of straight section 18, to further enhance the throughput of the assembly. The second curved section may provide approximately a 180 degree bend in the assembly (to achieve a generally S-shaped assembly) or any other angle of curvature which may be desired to adapt the sortation assembly to the space constraints of the particular application. Other shapes or configurations may be implemented without affecting the scope of the present invention.

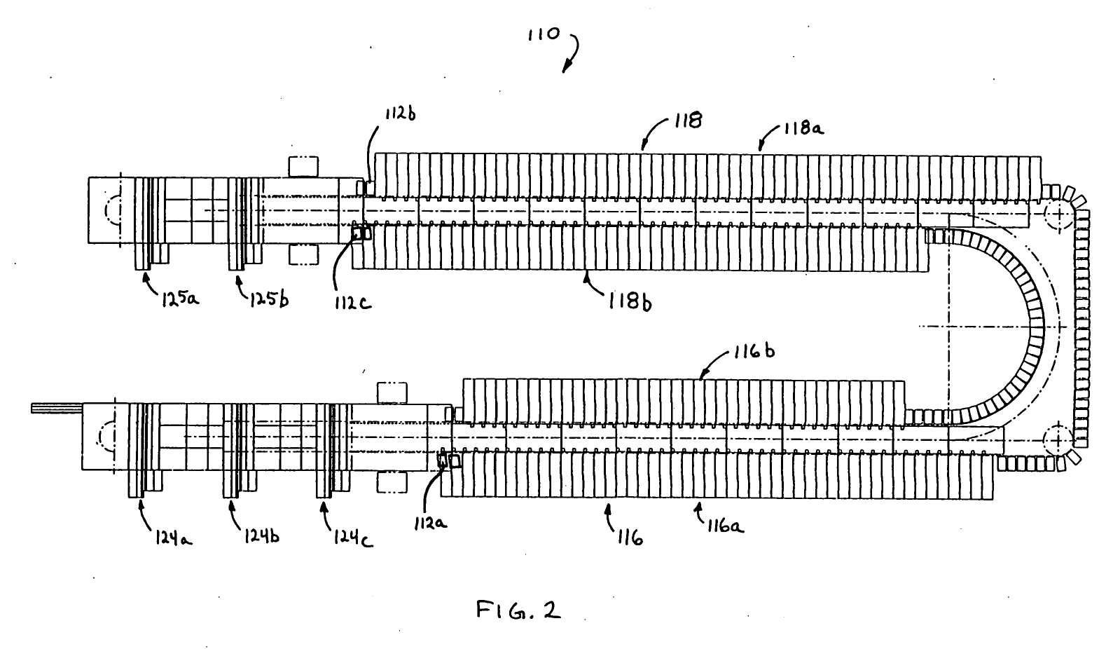

Optionally, as shown in FIG. 2, a sortation system 110 may include inducts 124a, 124b, 124c at the end of a straight section 116, and inducts 125a, 125b at the other end of the other straight section 118. This allows for greater efficiency and throughput of the sortation assembly, because the second set of inducts 125a, 125b may be operable to re-fill the chutes which have emptied their articles into the bins positioned along the outer sides of the straight sections 116, 118. The newly filled chutes then may dispense their articles into the bins positioned along the inner sides of the straight sections 116, 118 prior to being refilled again at inducts 124a, 124b, 124c, and so on. For example, chutes 112a may be filled or at least partially filled at inducts 124a, 124b, 124c with articles designated for the sort bins or stations positioned along the outer sides 116a, 118a of the straight sections 116, 118, such that the chutes 112b may be empty or substantially empty when they arrive at the second set of inducts 125a, 125b. The chutes may then be filled or at least partially filled by inducts 125a, 125b, such that chutes 112c may exit from the second inducts 125a, 125b with articles designated for the sort bins or stations positioned along the inner sides 118b, 116b of the straight sections 118, 116. Although shown with three inducts or feeders at one end and two inducts or feeders at the other end of the sortation assembly, other numbers of inducts may be implemented at either or both ends of the assembly without affecting the scope of the present invention. The remaining characteristics of sortation assembly 110 are substantially similar to sortation assembly 10, discussed above, such that a detailed discussion of the sortation assembly will not be repeated herein.

In the illustrated embodiment of FIG. 2, the first straight section 116 includes 90 bins or stations, but may include other quantities, depending on the application and desired layout of sortation assembly 110. The second straight section 118 includes 110 bins or stations, such that the illustrated embodiment of sortation assembly 110 provides 200 bins for sorting articles into, while maintaining a small enough footprint to be applicable in many facilities. In the illustrated embodiment, the overall width of the sortation assembly is only approximately 35 feet (10.55 meters), while the length is only approximately 103 feet (31.5 meters), which is less than approximately the length of a known 120 bin sorting machine, such as the AFSM 100. The sortation assembly of the present invention thus provides a much greater number of sort bins or stations, without a significant adverse affect on the space that the assembly occupies in the facility. It is further envisioned that additional bins may be provided along the outer curve portion 120b between the sprockets 126a, 126b, thereby further increasing the throughput of the sortation assembly.

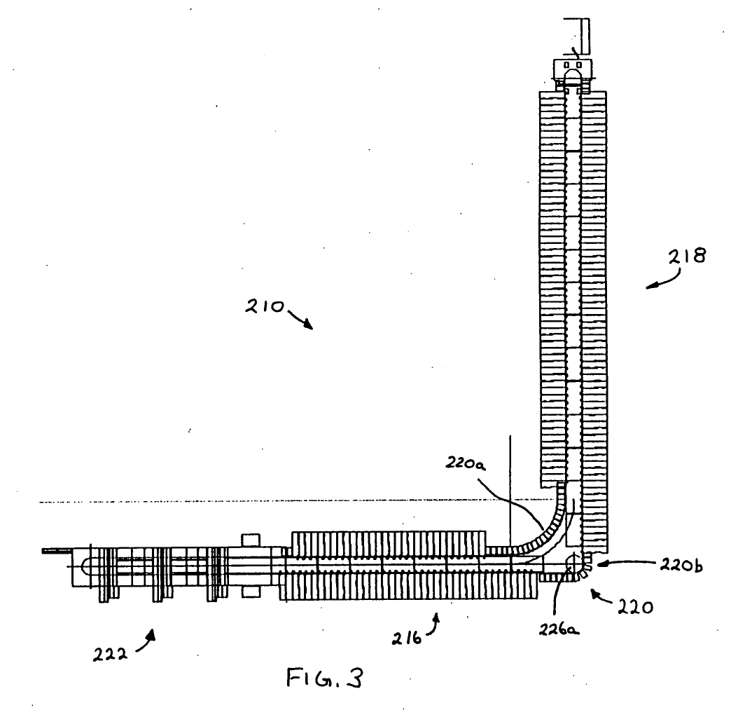

Referring now to FIG. 3, a sortation assembly 210 may include first and second straight sections 216, 218 connected by a curved section 220, whereby the curved section 220 provides a curve of less than approximately 180 degrees to the assembly, such as a curve of approximately 90 degrees, as shown in FIG. 3. The curved section 220 includes an inner curve 220a and an outer curve 220b, which is defined by an idler sprocket or the like 226a. Sortation assembly 210 is otherwise substantially similar to sortation assembly 10, discussed above, such that a detailed discussion of the sortation assembly will not be repeated herein. Optionally, sortation assembly 210 may include additional inducts (not shown) at the opposite end of the assembly from induct 222, without affecting the scope of the present invention. It is further envisioned that a second curved section and a third straight section may be added to the end of sortation assembly 210 to further increase the throughput of the assembly.

In the illustrated embodiment of FIG. 3, the first straight section 216 includes 70 bins or stations, but may include other quantities, depending on the application and desired layout of sortation assembly 210. The second straight section 218 includes 130 bins or stations, such that the illustrated embodiment of sortation assembly 210 provides 200 bins for sorting articles into while maintaining a small enough footprint to be applicable in many facilities.

Therefore, the present invention provides for a non-linear sortation assembly or machine and further provides for a method of modifying or retrofitting an existing flats mail sorter to a non-linear sortation assembly. For example, a linear sortation machine may be separated between a pair of adjacent sort modules, whereby additional modules and/or sort stations may be added to each separate section or portion of the machine to achieve a desired overall quantity of sort stations or bins on the sort machine. A curved section may then be connected between the separated portions to connect the separated portions into a non-linear sortation machine. The chain of the original linear machine may be replaced by a new chain of sufficient length for routing around both the separated portions and the curved section. The buckets or chutes are preferably mounted on the new chain at an increased pitch, to provide for greater separation between the buckets to allow the buckets to travel around the inner curve of the curved section without interference or binding of the buckets. The curved section may provide a 90 degree bend or a 180 degree bend or any other desired bend or curve to the non-linear sort machine, depending on the particular application and space constraints in the targeted facility.

The present invention thus provides for different orientations of the straight sections relative to one another and different layouts for the sortation assembly, in order to adapt the sortation assembly to different space constraints at the targeted facility. Although not shown, other shapes or designs may also or otherwise be implemented, such as an angled assembly having a curved section of greater than or less than approximately 90 degrees, without affecting the scope of the present invention.

Because the sortation assembly of the present invention includes additional bins, chutes and curves, it is envisioned that the chain drive mechanism may require additional power to move the chutes around the assembly. The additional power may be a motor with a greater output than a convention drive for a sorting machine, or may include a second drive sprocket, such as one of the sprockets of the outer curved section or the sprocket at the opposite end of the assembly from a conventional drive device. Optionally, a maintenance entrance may be provided at the curved section to allow maintenance personnel access to the central portion of the sortation assembly.

Therefore, the present invention provides a sortation assembly or machine or system which provides a greater amount of bins than a conventional sortation assembly, yet which may maintain a substantially reduced length to fit within the space constraints of the targeted facility. The sortation assembly of the present invention may include a pair of generally parallel straight sections or a pair of generally orthogonal straight sections, or any other angle between the straight sections, to adapt the assembly to the particular facility at which it is installed.

By implementing at least one curved section, the present invention may provide a non-linear sortation assembly, such as a generally U-shaped sortation assembly or a generally L-shaped sortation assembly, or any other desired shapes. The shape or layout of the sortation assembly of the present invention may be selected according to the particular application of the assembly and the space constraints of the facility at which the assembly is installed. By providing different shapes for the sortation assembly, the present invention allows for a greater number of bins or stations to be implemented on the sortation assembly, which results in greater efficiency and throughput in the sort process, while staying within the limited space constraints of the facility.

Changes and modifications in the specifically described embodiments may be carried out without departing from the principles of the present invention, which is intended to be limited only by the scope of the appended claims, as interpreted according to the principles of patent law.

The embodiments of the invention in which an exclusive property or privilege is claimed are defined as follows:

1. A sortation assembly for sorting articles, said sortation assembly comprising:
first and second straight sections;
a plurality of chutes movable along said first and second straight sections in a continuous loop, each of said straight sections including a plurality of sort stations along at least one side, said chutes being movable along and over said plurality of sort stations of both straight sections, said chutes being operable to deposit articles to bins or trays positioned at said sort stations; and
a curved connecting section which guides said plurality of chutes between said first and second straight sections.

2. The sortation assembly of claim 1, wherein said curved connecting section includes an outer curved track and an inner curved track along which said chutes are moved.

3. The sortation assembly of claim 1, wherein said straight sections are oriented generally orthogonal to one another, such that said sortation assembly is formed in a generally L-shaped pattern, said curved connecting section providing approximately a 90 degree bend in the travel path of said chutes.

4. The sortation assembly of claim 1, wherein said straight sections are oriented generally parallel to one another, such that said sortation assembly is formed in a generally U-shaped pattern.

5. The sortation assembly of claim 4, wherein said curved connecting section comprises one of a single approximately 180 degree curved connecting section and two approximately 90 degree curved connecting sections between said straight sections.

6. The sortation assembly of claim 1 including a plurality of inducts at one end of one of said first and second straight sections.

7. The sortation assembly of claim 1 including a plurality of inducts at both ends of said sortation assembly.

8. The sortation assembly of claim 1 including one or more inducts at said curved connecting section.

9. A method for extending a sortation assembly, said method comprising:
providing first and second generally straight sections of a sortation assembly, each of said first and second generally straight sections having a plurality of sort stations therealong;
providing a curved section between said first and second generally straight sections, said sortation assembly having a plurality of chutes for moving in a generally continuous loop around said generally straight sections and said curved section, said chutes being mounted to a drive member;
moving said chutes along said first and second generally straight sections and along said curved section via said drive member, said chutes being spaced along said drive member a sufficient amount to allow said chutes and said drive member to curve along said curved section without contact or interference occurring between adjacent ones of said chutes; and
depositing articles in said chutes to bins or trays positioned at said sort stations.

10. The method of claim 9, wherein said drive member comprises a chain.

11. The method of claim 10 including providing or spacing said chutes along said chain at an increased pitch or separation distance to allow for said chutes to curve along said curved section.

12. The method of claim 9, wherein said curved section includes an outer curved track and an inner curved track for moving said chutes and said drive member therealong.
